(19) United States
(12) Patent Application Publication
(10) Pub. No.: US 2021/0121015 A1
(43) Pub. Date: Apr. 29, 2021

(54) ELECTRIC GRILL THAT IS EASY TO CLEAN AFTER COOKING

(71) Applicant: Kyung-Il BAEK, Hwaseong-si (KR)

(72) Inventor: Kyung-Il BAEK, Hwaseong-si (KR)

(21) Appl. No.: 16/605,383

(22) PCT Filed: Sep. 13, 2017
(86) PCT No.: PCT/KR2017/010025

§ 371 Date: Oct. 15, 2019

(30) Foreign Application Priority Data
Apr. 15, 2017 (KR) 10-2017-0048835
Aug. 11, 2017 (KR) 10-2017-0102089

(51) Int. Cl. A47J 37/07; A47J 36/04; A47J 36/06; F24C 7/04

(52) U.S. Cl. CPC A47J 37/0722; A47J 37/0786; F24C 7/04; A47J 36/06; A47J 36/04

(57) ABSTRACT

An electric grill includes an electric heating means inside a main body case thereof to apply infrared heat to a material to be cooked and is easy to clean after cooking. The main body case includes pillar main body cases vertically extending from an upper surface of a lower main body case and having vertically-arranged electric heating means. The pillar main body cases are coupled to each other, forming an inner space. A heat-resistant container through which infrared light is transmitted has a long rectangular barrel or cylindrical shape and is formed from a material through which infrared light is transmitted, thereby providing a structure in the inner space in which heat (infrared radiation) is directly transmitted to the inside of the heat-resistant container. A grilling tool allows the material to be cooked to be mounted thereon and is capable of directly heating and cooking the material with infrared radiation.

### TECHNICAL FIELD

The present invention relates to an electric grill which includes an electric heating means inside a main body case thereof to apply infrared heat to a material M to be cooked, such as fish, meat, and the like to thereby cook the material M, and is easy to clean after cooking, and more particularly to an electric grill that is easy to clean after cooking, in which the main body case includes a plurality of pillar main body cases which vertically extend from an upper surface of a lower main body case, are provided therein with a vertically-arranged electric heating means, and are coupled to each other, wherein, when the plurality of pillar main body cases are coupled to each other, an inner space is vertically formed, and a heat-resistant container through which infrared light is transmitted, having only an upper opening, having a long rectangular barrel or cylindrical shape in a height direction, and made of a material through which infrared light is transmitted, such as glass or the like is arranged in the vertically formed inner space, thereby providing a structure in which infrared radiation passes through the heat-resistant container and is directly applied to the inside thereof, and a grilling tool allowing the material M to be cooked to be mounted thereon and capable of directly heating and cooking the material M with infrared radiation is provided inside the heat-resistant container, and thus cooking is convenient, water, oil, a contaminant, and the like leaked from the material M to be cooked flow down along the sidewalls of the heat-resistant container and are collected at the bottom of the container, thus preventing the inside of the electric grill from being contaminated by using the heat-resistant container, and all treatments for water, oil, contaminants, and the like directly generated from the material M to be cooked during the cooking process may be finished by simply washing the heat-resistant container.

### BACKGROUND ART

In conventional electric grills, heaters are arranged inside upper and lower portions of a hexahedral or cylindrical box and a material to be cooked is positioned at the center of the box to heat the material at upper and lower sides. During cooking, water, oil, steam, odor, gas, fine dust, and the like, which are generated from the material to be cooked (fish, meat, and the like) contaminate all components, such as inner walls, bottom, heaters, and the like, of the grill, and thus there have been problems such as near impossibility to clean, continuous smell, pollution of indoor air due to harmful gases and fine dust inside the steam discharged to the outside of the grill, and the like.

In addition, according to Korean Registered Utility Model Gazette No. 20-0319297, a container is manufactured as an infrared opaque container made of an iron plate or the like, but a cover thereof is made of a glass plate, and a heater is installed on the upper surface, i.e., the glass plate, of the container, as an attempt to prevent the grill from being contaminated with water, oil, contaminants, and the like, but in this structure, since contaminants flow down the container and are accumulated on the floor, a heater cannot be installed on the lower side (if a heater is installed on the lower side, oils among the contaminants flowing down the container are combusted, thus causing a lot of smoke and fire). Thus, during cooking, many problems occur such as a need to continuously check the material M to be cooked by opening the cover, turning the material M over to cook the rear side thereof, and the like.

### DISCLOSURE

### Technical Problem

Therefore, the present invention has been made in view of the above problems, and it is one object of the present invention to provide an electric grill which includes an electric heating means in a main body case to apply infrared heat to a material M to be cooked such as fish, meat, or the like to thereby cook the material M, and is easy to clean after cooking, wherein the main body case includes a plurality of pillar main body cases which vertically extend from an upper surface of a lower main body case, are provided therein with a vertically-arranged electric heating means, and are coupled to each other, wherein, when the plurality of pillar main body cases are coupled to each other, an inner space is vertically formed, and a heat-resistant container through which infrared light is transmitted, having only an upper opening, having a long rectangular barrel or cylindrical shape in a height direction, and made of a material through which infrared light is transmitted, such as glass or the like is arranged in the vertically formed inner space, thereby providing a structure in which infrared radiation passes through the heat-resistant container and is directly applied to the inside thereof, and a grilling tool allowing the material M to be cooked to be mounted thereon and capable of heating and cooking the material M with infrared radiation is provided inside the heat-resistant container, and thus cooking is convenient, water, oil, contaminants, and the like leaked from the material M to be cooked flow down along the sidewalls of the heat-resistant container and are collected at the bottom of the container, thus preventing the inside of the electric grill from being contaminated by using the heat-resistant container, and water, oil, contaminants, and the like directly generated from the material M to be cooked during the cooking process may be eliminated by simply washing the heat-resistant container.

### Technical Solution

In accordance with one aspect of the present invention, provided is an electric grill that is easy to clean after cooking, which includes a main body case and an electric heating means inside the main body case, in which a material M to be cooked is mounted on a grilling tool and heat is applied to the material M to cook the material M, wherein the main body case includes a plurality of pillar main body cases extending from an upper surface of a lower main body case, provided therein with a vertically-arranged electric heating means, and coupled to each other, wherein, when the plurality of pillar main body cases are coupled to each other, an inner space is vertically formed, a heat-resistant container through which infrared light is transmitted, having only an upper opening, having a long rectangular barrel or cylindrical shape in a height direction, and made of a material through which infrared light is transmitted, such as glass or the like is arranged in the vertically formed inner space, thereby providing a structure in which infrared radiation passes through the heat-resistant container and is directly applied to the inside thereof, and the grilling tool is arranged inside the heat-resistant container, the grilling tool allowing the material M to be mounted thereon and being capable of heating and cooking the material M.

In addition, the plurality of pillar main body cases coupled to each other has a tetragonal barrel shape or a tetragonal barrel shape with a cylindrical inner space.

In addition, to prevent an increase in temperature of an exterior of the main body case, each pillar main body case has a plurality of air holes in a side surface thereof, and the lower main body case has a plurality of air holes in a lower surface thereof.

In addition, the heat-resistant container includes a handle protruding laterally and configured to hold the heat-resistant container, and at least one slit is provided from an upper end portion to a middle portion of the main body case and configured to guide the protruding handle of the heat-resistant container to be accommodated therein, when the plurality of pillar main body cases are coupled to each other.

In addition, a circumferential surface of the heat-resistant container is made of heat-resistant glass, and a lower surface thereof is made of a heat-resistant material different from the heat-resistant glass of the circumferential surface, thereby preventing occurrence of cracks in the heat-resistant container.

In addition, the grilling tool includes a grill handle configured to hold the grilling tool, a pair of grills provided below the grill handle and on which the material M to be cooked is mounted, a pair of fasteners that fasten the pair of grills to rigidly mount the material M to be cooked, and a locking loop that fixes a fastened state of the pair of fasteners.

In addition, the electric grill further includes a cap on an upper portion of the heat-resistant container.

In addition, the cap includes a filter that filters polluted gases including odors generated during cooking and discharges the gases to the outside, and further includes a cap accommodation hole in a side surface of the cap, the cap accommodation hole being capable of accommodating an outwardly-protruding portion of the grilling tool.

### Advantageous Effects

As is apparent from the foregoing description, an electric grill which is easy to clean after cooking, according to the present invention, has a structure in which a heat-resistant container having a long rectangular barrel or cylindrical shape in a height direction and made of a material through which infrared light is transmitted, such as glass or the like is arranged in a main body case, thereby providing a structure in which infrared radiation passes through the heat-resistant container and is directly applied to the inside thereof and a grilling tool allowing the material M to be cooked to be mounted thereon and capable of heating and cooking the material M is arranged inside the heat-resistant container, and thus water, oil, contaminants, and the like leaked from the material M to be cooked during cooking flow down along the sidewalls of the heat-resistant container and are collected at the bottom of the container, thus preventing the inside of the electric grill from being contaminated by using the heat-resistant container, and water, oil, contaminants, and the like directly generated from the material M to be cooked during the cooking process may be eliminated by simply washing the heat-resistant container after cooking, thereby achieving an effect in which cleaning after cooking is easy.

In addition, cooking is performed by a plurality of electric heating means vertically installed in many directions inside the main base case, and thus there is no need to check, during cooking, a degree to which a front or rear side of the material M to be cooked is cooked and there is no inconvenience such as turning the rear side thereof over, thus achieving an effect on convenient cooking.

In addition, in the present invention, the heat-resistant container has a long rectangular barrel or cylindrical shape in a height direction so as to vertically accommodate and cook the material M to be cooked, and thus the material M to be cooked can be vertically accommodated therein and cooked, and accordingly, the heat-resistant container occupies a small area of the floor, thus being convenient to use on a table anytime for specific purposes such as fish grilling, barbecuing of a small piece of steak, and the like.

In addition, in the present invention, a plurality of air holes are formed in side surfaces of vertically-extending pillar main body cases of the main body case, and a plurality of air holes are formed in a lower surface of a lower main body case, thus providing an effect of preventing an increase in temperature of the exterior of the main body case.

In addition, in the present invention, at least one heat-resistant container handle, which protrudes from a side surface of the heat-resistant container and is configured to hold the heat-resistant container, is formed, and at least one slit is formed from an upper end to middle portion of the side surface of the main body case so as to guide and accommodate the protruding heat-resistant container handle, and thus during cooking, the heat-resistant container may be easily accommodated by grabbing the heat-resistant container, and even immediately after cooking is completed, the heat-resistant container can be taken out right away since the heat-resistant container handle is not hot.

In addition, in the present invention, a circumferential surface of the heat-resistant container is made of heat-resistant glass, and a lower surface thereof is made of a heat-resistant material different from the heat-resistant glass of the circumferential surface, thus providing an effect of preventing the occurrence of cracks during heating in a repeated cooking process.

In addition, in the present invention, the grilling tool includes a grill handle configured to hold the grilling tool, a pair of grills provided below the grill handle and on which the material M to be cooked is mounted, fasteners configured to fasten the pair of grills to rigidly mount the material M to be cooked, and a locking loop that fixes the fastened state of the fastener, and the like, thus providing an effect of rigidly and conveniently mounting the material M to be cooked.

In addition, in the present invention, a cap provided in an upper portion of the heat-resistant container includes a filter 71 that filters polluted gases including odor which are generated during cooking and discharges the gases to the outside, and cap accommodation holes capable of accommodating portions of the grilling tool which protrude to the outside of the heat-resistant container, and thus the cap is capable of hermetically sealing the heat-resistant container, thereby providing an effect of discharging, to the outside, polluted gases including odors which are generated in a cooking process, through filtering.

### DESCRIPTION OF DRAWINGS

FIG. 1 is an exploded perspective view of main modules of an electric grill that is easy to clean after cooking, according to the present invention.

FIG. 2A is a view illustrating a state in which a material to be cooked (e.g., fish) is being mounted, according to the present invention, and FIG. 2B is a view illustrating a state in which the material to be cooked (e.g., fish) is mounted, according to the present invention.

FIG. 3 is an overall exploded perspective view of an electric grill that is easy to clean after cooking, according to the present invention.

FIG. 4 is a perspective view for the understanding of arrangements of electric heating means, a reflective plate, and the exterior of a main body, according to the present invention.

FIG. 5 is a view for explaining a state in which a heat-resistant container is heated by surrounding electric heating means, according to the present invention.

FIG. 6 is a view for explaining heating and air flow, according to the present invention.

FIG. 7 is an exploded perspective view of a heat-resistant container according to the present invention.

FIG. 8 is a cross-sectional view of a heat-resistant container according to the present invention.

FIG. 9 is a view for explaining problems that may occur when a heat-resistant container is made of a single material.

FIG. 10 is an exploded perspective view of a grilling tool according to the present invention.

FIG. 11A is a front view of a grilling tool according to the present invention, and FIGS. 11B and 11C are side views of the grilling tool.

FIGS. 12A to 12C are views illustrating a process of mounting a material M to be cooked on the grilling tool according to the present invention.

FIG. 13 is an exploded perspective view of a cap according to the present invention.

FIG. 14 is a cross-sectional view of a cap according to the present invention.

FIG. 15A is a side view illustrating a state in which a cap is coupled to a grilling tool, and FIG. 15B is a cross-sectional view taken along line A-A of FIG. 15A.

<Description of Reference Numerals>

| | |
|---|---|
| M: Material to be cooked | IR: Infrared radiation |
| 10: Main body case | 11: Pillar main body case |
| 11a: Lower air hole | 11b: Upper air hole |
| 12: Lower main body case | 12a: Upper cover |
| 12b: Lower plate | 12c: bottom air hole |
| 15: Upper edge cover | 16: Connecting plate |
| 21: Infrared heater | 30: Reflective member |
| 40: Heat-resistant container | 41: Heat-resistant container handle |
| 42: Lower cap | 43: Packing |
| 50: Grilling tool | 51: Grill |
| 51a: Hinge shaft | 51b: Horizontal bar |
| 52: Fastener | 52a: Hinge portion |
| 52b: Fastening bar | 52c: extension portion |
| 52d: Fastening portion | 53: Grill handle |
| 54: Connecting unit | 55: Locking loop |
| 55a: Press plate | 56: Rack |
| 57: Resting portion | 61: Electric plug |
| 62: Manipulation handle | 64: Electric controller |
| 70: Cap | 71: Filter |
| 72: Cover | 73: Gas outlet |
| 74: Cap accommodation hole | |

### BEST MODE

The present invention relates to an electric grill which includes an electric heating means inside a main body case thereof to apply infrared heat to a material M to be cooked, such as fish, meat, or the like, to thereby cook the material M, and which is easy to clean after cooking, and the electric grill which is easy to clean after cooking, according to the present invention, will be described in detail with reference to the accompanying drawings.

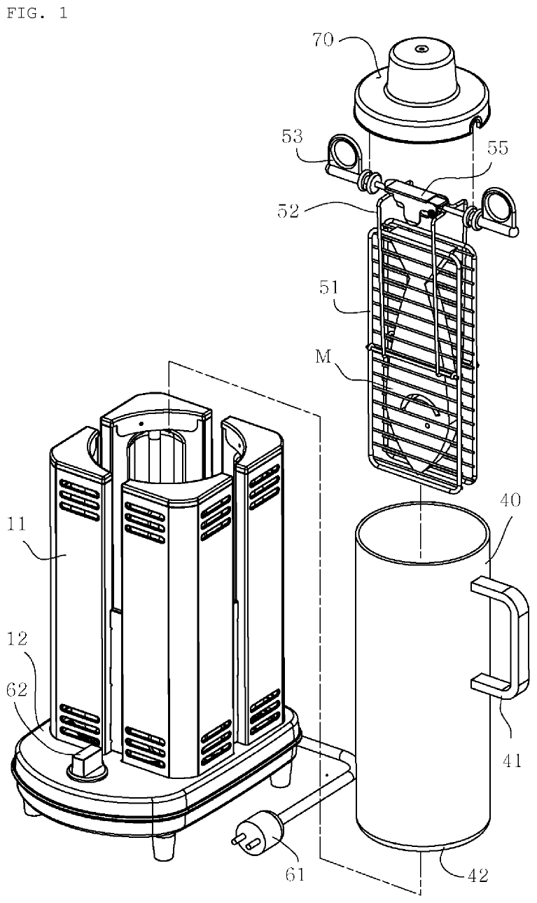

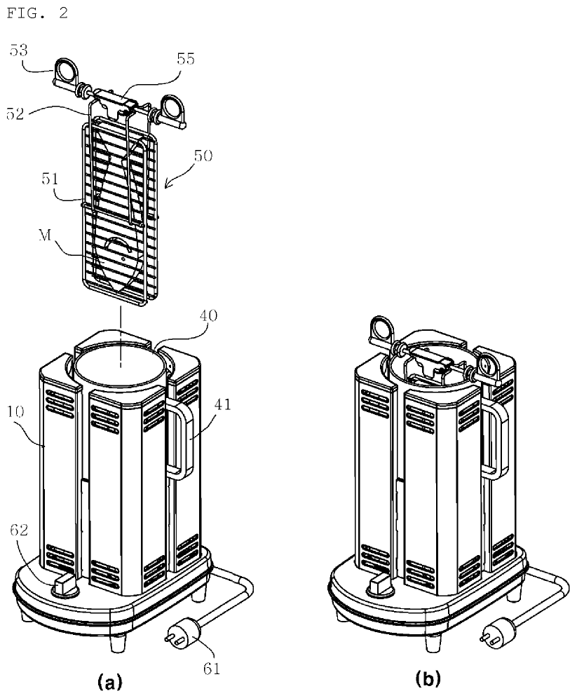

The electric grill which is easy to clean after cooking, according to the present invention, will be described with reference to FIGS. 1 to 6.

As illustrated in FIGS. 1 to 6, an electric grill which is easy to clean after cooking, according to the present invention, has a structure in which an electric heating means is provided inside a main body case 10 and a heat-resistant container 40 having a long rectangular barrel or cylindrical shape in a height direction is arranged in a long space vertically formed inside the main body case 10, to apply heat to the heat-resistant container 40, and a grilling tool 50 allowing the material M to be cooked to be mounted thereon and capable of heating and cooking the material M is provided inside the heat-resistant container 40.

The main body case 10 includes a lower main body case 12, a plurality of pillar main body cases 11 vertically extending from an upper surface of the lower main body case 12, and the like. The lower main body case 12 is provided, at one side thereof, with a switch which allows a user to turn the electric grill ON/OFF, a manipulation handle 62 capable of adjusting an exothermic temperature, and the like, and is provided therein with an electric controller 64 and an electric circuit (not shown) that supplies electricity from the outside.

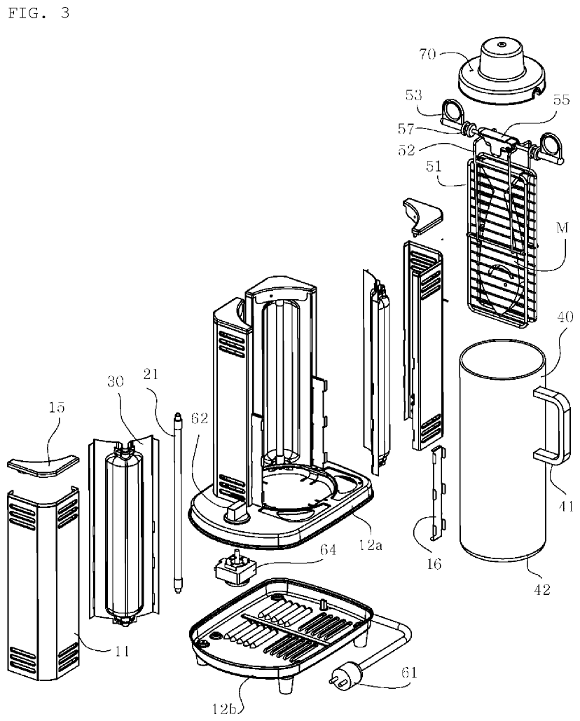

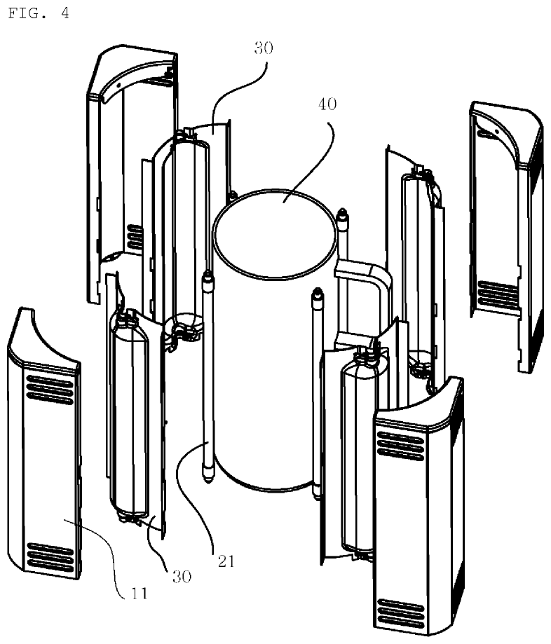

As illustrated in FIGS. 3 and 4, each pillar main body case 11 has a shape with long edges vertically formed, a reflective member 30 having a curved shape and capable of reflecting infrared light is installed inside the pillar main body case 11, and an electric heating means such as an infrared heater 21 or the like is installed inside the reflective member 30. That is, the reflective member 30 reflects infrared heat generated from the infrared heater 21 towards the heat-resistant container 40, which is made of a material through which infrared light is transmitted, such as glass or the like, thereby increasing thermal efficiency through direct heating by the infrared radiation transmitted to the inside of the heat-resistant container 40.

As illustrated in FIGS. 1 to 6, the pillar main body cases 11 may have a rectangular barrel shape in such a way that 4 pillar main body cases are connected to each other and an internal space, which has a long rectangular barrel or cylindrical shape in a height direction, is capable of accommodating the heat-resistant container 40, and is vertically formed, is formed therein. In some cases, however, the pillar main body cases 11 may also have a polygonal barrel shape such as a triangular, pentagonal, or hexagonal barrel shape or the like in such a way that a plurality of pillar main body cases are connected to each other and an internal space is vertically formed therein. Hereinafter, the case where 4 pillar main body cases are connected to each other will mainly be described below with reference to FIGS. 1 to 6. The internal space formed as a result of connecting the plurality of pillar main body cases 11 to each other has a vertically long rectangular barrel or cylindrical shape.

Four pillar main body cases 11 are assembled with each other via connecting plates 16 to thereby have a substantially rectangular barrel shape that is long in a height direction, and each pillar main body case 11 is provided, at an upper end portion thereof, with an upper edge cover 15. A connection portion of each pillar main body case 11 is formed from a lower end portion to middle portion of the main body case 10 in such a way that the connecting plate 16 is formed at a lower height than the pillar main body case 11 such that a slit is formed from the upper end portion to middle portion of the main body case 10. At least one slit may be formed from the upper end portion to middle portion of the main body case 10 and may guide a handle of the heat-resistant container 40 to be arranged therein. As described above, the structure in which a plurality of pillar main body cases 11 are able to be assembled with each other is easy to manufacture, but the pillar main body cases 11 may also be molded in an integrated form.

In addition, to prevent an increase in temperature of the exterior of the main body case 10, as illustrated in FIG. 6, a plurality of lower air holes 11a are formed in lower portions of side surfaces of the pillar main body case 11 which covers a reflective member, upper air holes 11b are formed in upper portions of the side surfaces of the pillar main body case 11, and a plurality of bottom air holes 12c are formed in a lower surface of the lower main body case 12.

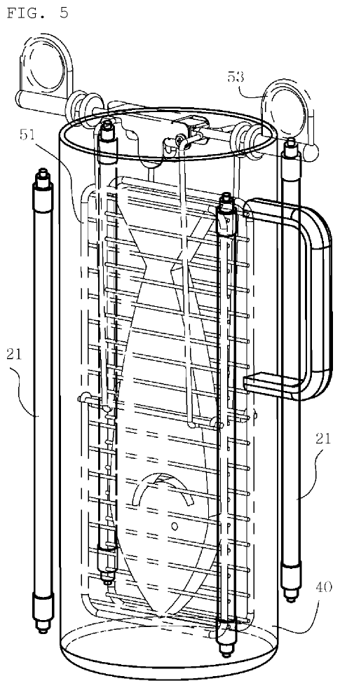

The electric heating means uses the infrared heater 21 having a large length as an electric heater that emits infrared radiation, and four infrared heaters are installed in four directions of the main body case 10 to emit infrared light towards the heat-resistant container 40 in the four directions. That is, as illustrated in FIG. 5, the infrared heaters 21 are installed vertically to a long length in the main body case 10 in four directions to emit infrared radiation towards the material M to be cooked from the four directions, thereby heating and cooking the material M to be cooked.

The reflective member 30 is installed inside each of the pillar main body cases 11 to reflect infrared heat generated from the infrared heater 21 in four directions, and a reflective plate is installed at an angle at which the infrared heat generated from the infrared heater 21 is concentrated on the material M to be cooked accommodated in the heat-resistant container 14 and reflected therefrom.

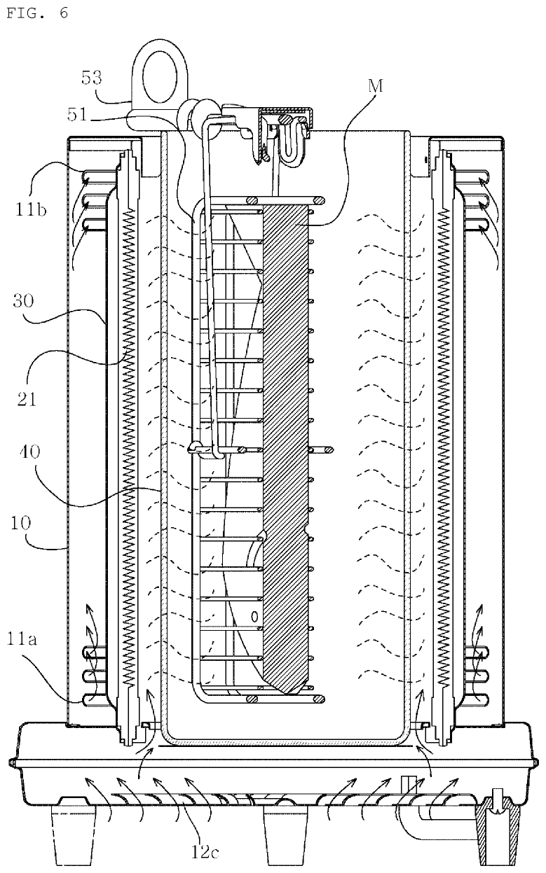

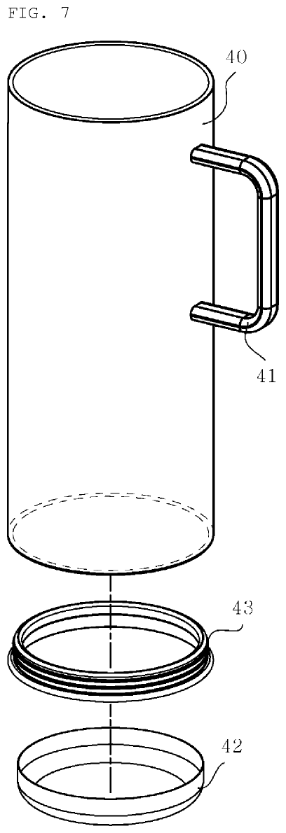

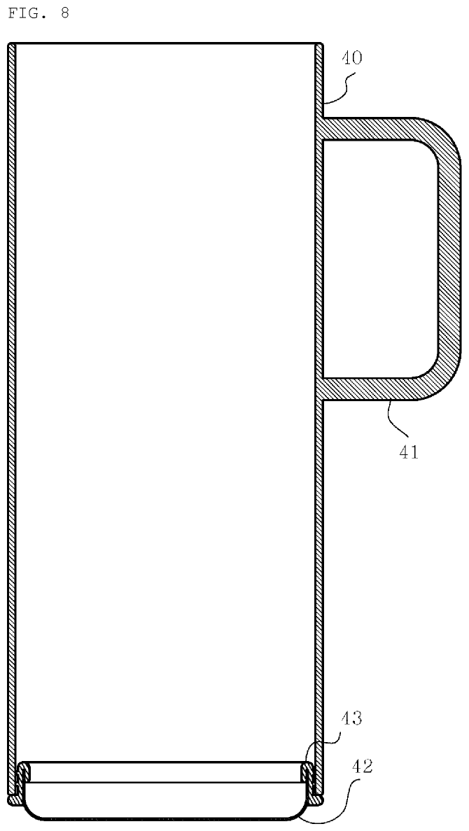

The heat-resistant container 40 is installed in an internal space formed as a result of connecting four pillar main body cases 11 to each other and having a long rectangular barrel or cylindrical shape in a height direction, and is made of barrel-shaped, heat-resistant glass or the like through which infrared light is able to pass and having only an upper opening, and the material M to be cooked, which is mounted on the grilling tool 5, is accommodated inside the heat-resistant container 40 through the upper opening. Infrared radiation generated and emitted from the infrared heaters 21 and reflective plates, which are the reflective members 30, passes through the heat-resistant container 40 and is directly transmitted to the material M to be cooked, thereby heating and cooking the material M to be cooked. The heat-resistant container 40 has a barrel shape with only an upper opening, and thus water, oil, contaminants, and the like leaked from the material M to be cooked in heating and cooking processes flow down along sidewalls of the heat-resistant container 40 and are collected at the bottom of the heat-resistant container 40, thereby preventing the inside of the electric grill from being contaminated, by using the heat-resistant container 40, and all treatments for water, oil, contaminants, and the like directly generated from the material M to be cooked in the cooking process may be finished by simply washing the heat-resistant container 40. In addition, the heat-resistant container 40 may be provided, at a side surface thereof, with one or more protruding heat-resistant container handles so as to easily accommodate the heat-resistant container 40 by holding the heat-resistant container 40 (one handle is illustrated in FIGS. 7 and 8, preferably one or two handles). In a case where heat-resistant container handles are provided at opposite side surfaces of the heat-resistant container 40, the heat-resistant container handles are guided along and caught in slits, each of which is formed from an upper end portion to a middle portion of the connection portion formed when the pillar main body cases 11 are connected to each other, thus facilitating accommodation of the heat-resistant container 40. In this case, the infrared heaters 21 and the reflective members 30 that reflect infrared light are also installed at opposite sides of the slit so as not to interfere with guiding and accommodation of the heat-resistant container handles along and in the slits. The heat-resistant container handle may be vertically integrated with the heat-resistant container 40 or may be assembled and installed at a side surface of the heat-resistant container 40. [70] FIG. 9 is a view for explaining problems that may occur when a heat-resistant container is made of a single material. As illustrated in FIG. 9, when a heat-resistant container applied to the electric grill according to the present invention is made of a single material, contaminants 100 and 101 such as water, oil, and the like which are generated from the material M to be cooked are collected at the bottom and accordingly, the temperature of a bottom portion of the heat-resistant container is not raised to 100° C. or higher due to the contaminants or the bottom portion thereof is maintained cooler by cooling air flow of a main body of the heat-resistant container 40, whereas the temperature of an upper portion of the heat-resistant container 40 is raised to 300° C. to 400° C. by the infrared heaters 21, and thus the heat-resistant glass undergoes thermal expansion stress in directions opposite to each other as illustrated as arrows F. When such a phenomenon is repeated several tens of times, as illustrated in FIG. 9, cracks occur in a lower portion of the heat-resistant glass by fatigue fracture at any moment, resulting in destruction thereof. In the present invention, causes thereof have been identified through many experiments and as a method capable of coping with the causes, the lower portion of the heat-resistant glass has been separately made of a socap heat-resistant material such as a metal, glass, rubber, or the like, thus preventing the occurrence of such accidents.

As illustrated in FIGS. 7 and 8, a circumferential surface of the heat-resistant container 40 is made of heat-resistant glass, and a lower surface thereof is made of a heat-resistant material different from the heat-resistant glass. That is, the heat-resistant container 40 is configured such that the circumferential surface is made of heat-resistant glass, and for the lower surface, a lower cap 42 made of a material different from the heat-resistant glass is used and a packing 43 made of rubber or the like is used to hermetically assemble the heat-resistant glass of the circumferential surface and the lower cap 42, and thus when the heat-resistant container 40 is repeatedly heated, the occurrence of cracks therein is prevented.

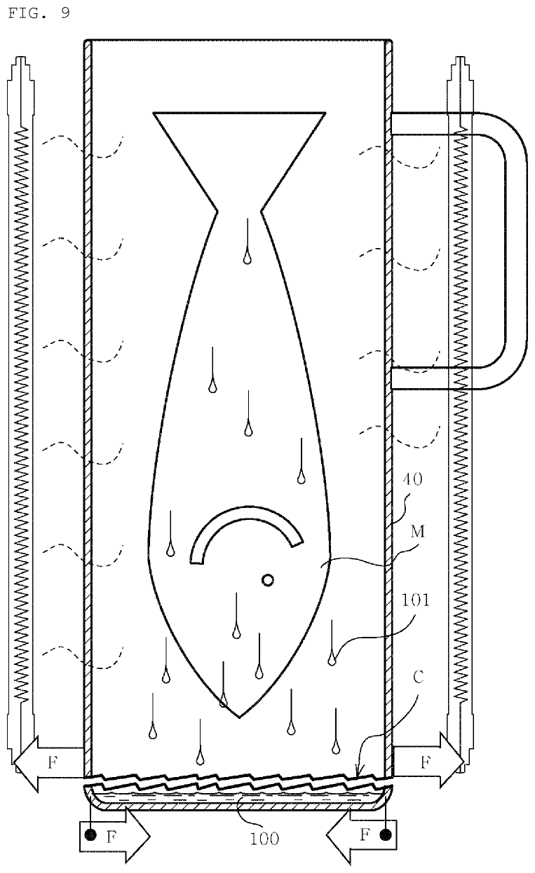

As illustrated in FIGS. 10 to 12, the grilling tool 50 includes a grill handle 53 allowing a user to hold the grilling tool 50, a pair of grills 51 provided below the grill handle 53 and on which the material M to be cooked is mounted, a pair of fasteners 52 that fasten the pair of grills 51 to rigidly mount the material M to be cooked, a locking loop 55 that fixes the fastened state of the pair of fasteners 52, and the like.

The pair of grills 51 has the same shape and each grill includes a frame with four curved edges and having a tetragonal shape, a plurality of horizontal bars 51b provided inside the tetragonal frame in parallel to each other at a constant interval, and a hinge shaft 51a horizontally provided at a surface opposite to the surface at which the horizontal bars 51b are provided.

Each of the pair of fasteners 52 that fasten the pair of grills 51 includes hinge portions 52a that are provided at a lower portion of each fastener and are hinge-coupled with the hinge shaft 51a, a pair of fastening bars 52b upwardly extending from the respective hinge portions 52a, extension portions 52c horizontally and curvedly extending from opposite upper end portions of the pair of fastening bars 52b, a fastening portion 52d protruding downwardly from a central portion of the opposite extension portions 52c and having a U-shaped protrusion shape, and the like.

The locking loop 55 that fixes the fastened state of the pair of fasteners 52 has a rotational structure and is provided, on a side thereof, with press plates 55a that reduce a distance between the pair of fastening portions 52d having a U-shaped protrusion shape.

In addition, the grilling tool 50 includes a rack that holds the pair of grill handles 53 at opposite sides thereof above the pair of fastening bars 52b, and the rack 56 is provided with resting portions 57 allowing the grilling tool 50 to be rested on an upper circumferential surface of the heat-resistant container 40, each resting portion having a hole provided at an internal position thereof where the grill handle 53 is held. In addition, the grilling tool 50 includes a “LI”-shaped connecting unit 54 through which the rack 56 is inserted and which is arranged at the center of the rack 56, and which has a lower opening and openings in portions of opposite side surfaces thereof, in which the pair of fastening portions 52d having a U-shaped protrusion shape are provided at the openings in the opposite side surfaces thereof. The pair of fastening portions 52d having a U-shaped protrusion shape, which are provided at the opposite side surfaces of the connecting unit 54 is fastened by the press plate 55a by rotating the locking loop 55.

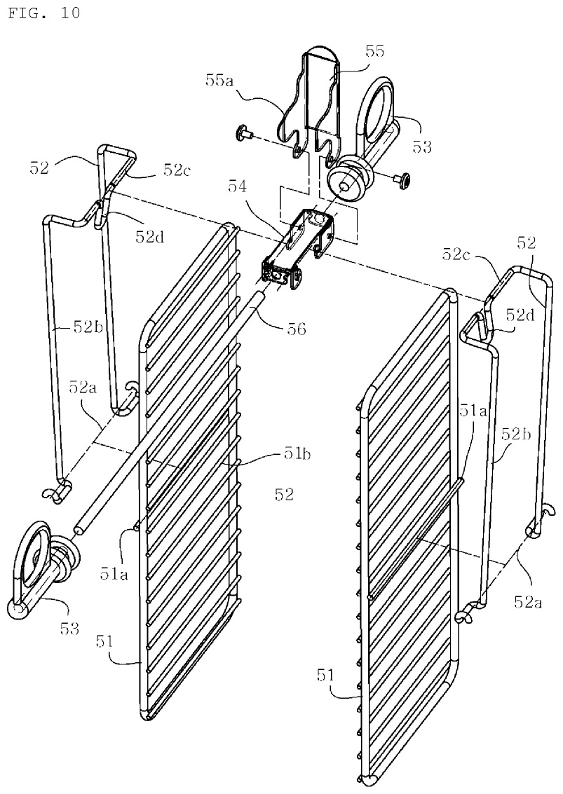

A configuration of mounting the material M to be cooked on the grilling tool 50 will now be described with reference to FIGS. 11A to 11C.

FIG. 11A is a front view of the grilling tool 50 according to the present invention, FIG. 11B is a side view illustrating a state in which the locking loop 55 is unlocked and the material M to be cooked is not mounted on the grilling tool 50, and FIG. 11C is a side view illustrating a state in which the material M to be cooked is mounted on the grilling tool 50 by rotating the locking loop 55 (for convenience of explanation, the material M to be cooked is not illustrated in the drawings).

As illustrated in FIG. 11B, the state in which the locking loop 55 is unlocked and the material M to be cooked is not mounted on the grilling tool 50 is a state in which the fastening bars 52b are parallel to the grills 51, i.e., a state of not pressing the grills 51. In this regard, the pair of fastening portions 52d having a U-shaped protrusion shape outwardly protrude in an inclined manner.

As illustrated in FIG. 11C, when the locking loop 55 is rotated, the press plates 55a inwardly move the pair of fastening portions 52d having a U-shaped protrusion shape, which outwardly protrude in an inclined manner. In this case, a pair of hinge portions 52a respectively provided at lower end portions of the pair of fastening bars 52b are rotated about the hinge shaft 51a of each of the pair of grills 51, and accordingly, the pair of fastening bars 52b inwardly push the pair of grills 51, thereby rigidly mounting the material M to be cooked.

The fasteners 52 are made of a metal or the like to have a large length and have spring-like elasticity like a bow so that the material M to be cooked can be rigidly mounted within a certain interval at all times regardless of the thickness of the material M.

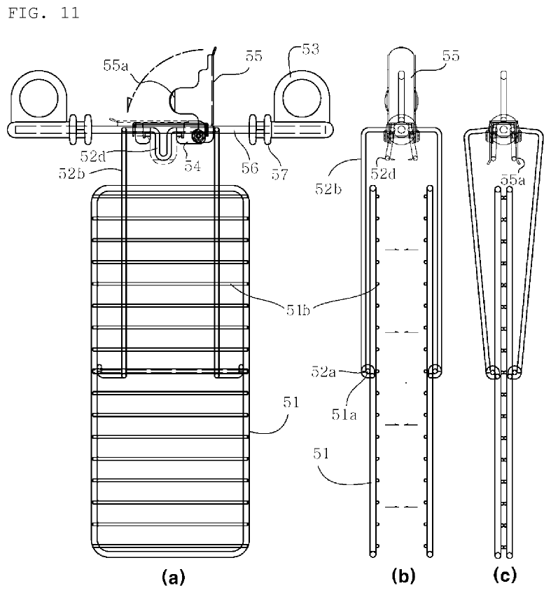

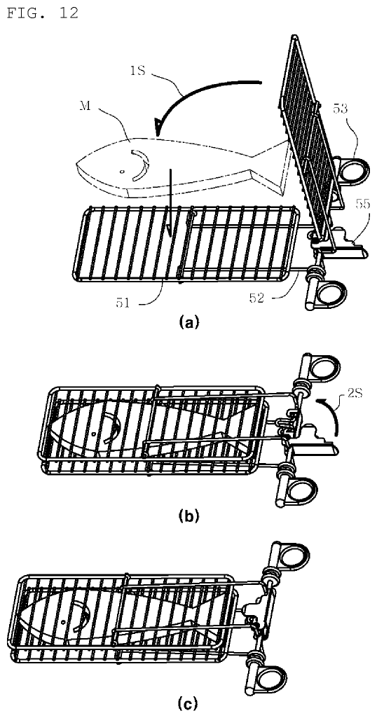

A process of mounting the material M to be cooked on the grilling tool 50 according to the present invention will be described with reference to FIGS. 12A to 12C.

One of the pair of grills 51 is lifted, the material M to be cooked is mounted on the other grill 51 (see FIG. 12A), the lifted grill 51 is rotated to be arranged in parallel to the other grill 51, so that the material M to be cooked is sandwiched between the pair of grills 51 (see FIG. 12B). Next, the locking loop 55 is rotated to fix the fastened state of the fasteners 52 that fasten the pair of grills 51 arranged in parallel to each other (see FIG. 12C), thereby rigidly mounting the material M to be cooked, on the grilling tool 50.

In addition, for convenient cooking, the present invention may further include a cap 70 provided with a filter that filters polluted gases including odors generated during cooking and discharge the gases to the outside, although cooking is performed without the cap 70, and the cap 70 seals an upper portion of the heat-resistant container 40 to thereby maintain a pleasant environment during cooking.

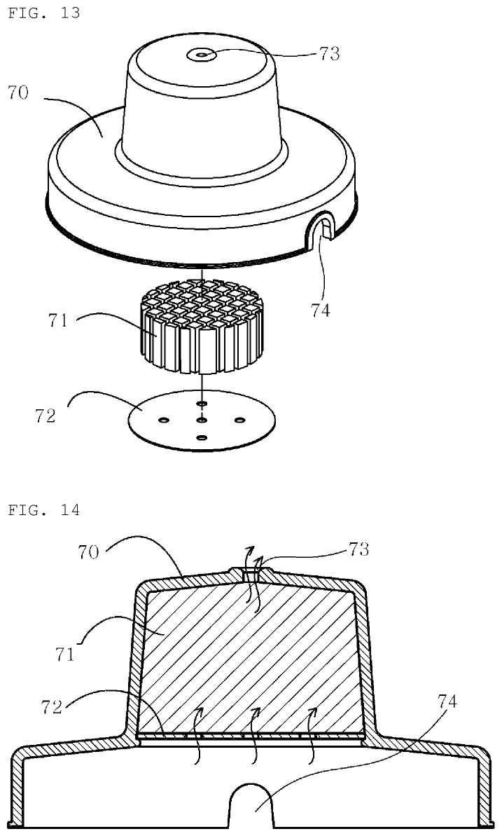

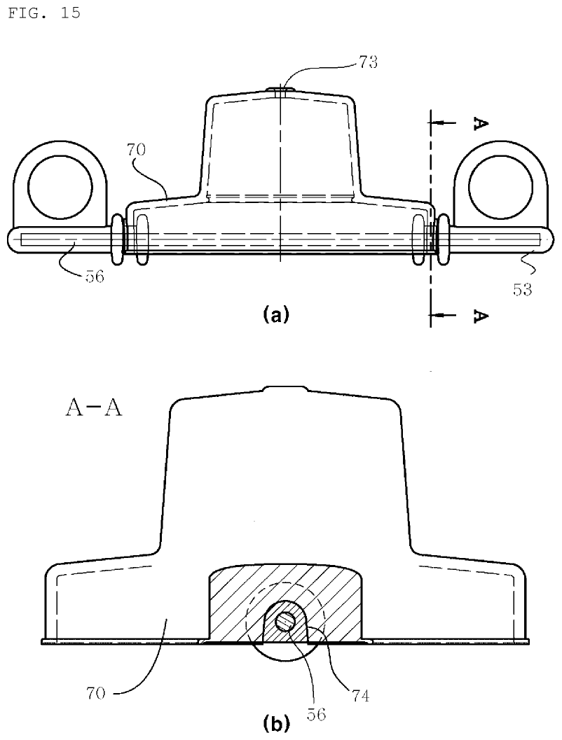

As illustrated in FIGS. 13 to 15, the cap 70 has an outer diameter portion sufficient to seal the heat-resistant container 40 and an upwardly protruding small-diameter portion which is provided on an inner side of the inner diameter portion and allows a user to easily hold the cap 70.

The upwardly protruding small-diameter portion is provided therein with a filter 71 that filters polluted gases including odors generated during cooking and discharges the gases to the outside, and a cover 72 on which the filter 71 is able to be mounted. The cover 72 has a plurality of gas through-holes through which, when the heat-resistant container 40 is sealed, polluted gases including odors generated from the heat-resistant container 40 pass to allow the gases to pass through the filter 71. The cap 70 further includes a gas outlet 73 in an upper portion of the upwardly protruding small-diameter portion to discharge the gases including odors, which have been filtered through the filter 71.

The cap 70 includes cap accommodation holes 74 having an “inverted U” shape in lower end portions of opposite sides of the outer-diameter portion to maintain the sealed state even in a state where the grilling tool 50 is accommodated in the heat-resistant container 40. The resting portions 57 provided in the grilling tool 50 may be accommodated in the cap accommodation holes 74 so that the heat-resistant container 40 is sealed by the cap 70.

In the present invention, the heat-resistant container 40 has a long rectangular barrel or cylindrical shape in a height direction so as to vertically accommodate and cook the material M to be cooked, and thus the material M to be cooked may be vertically accommodated therein and cooked, and accordingly, the heat-resistant container 40 occupies a small area of the floor, thus being convenient to use on a table anytime for specific purposes such as fish grilling, barbecuing of a small piece of steak, and the like.

While the present invention has been described with reference to the aforementioned exemplary embodiments thereof, it will be understood by those of ordinary skill in the art that various changes or modifications can be made without departing from the spirit and scope of the present invention as defined by the following claims.

### INDUSTRIAL APPLICABILITY

The present invention relates to an electric grill which includes an electric heating means inside a main body case to apply infrared heat to the material M to be cooked such as fish, meat, or the like to thereby cook the material M and is easy to clean after cooking, and the electric grill may be widely used in the electric grill field.

1. An electric grill that is easy to clean after cooking, comprising:
a main body case and an electric heating means inside the main body case, in which a material M to be cooked is mounted on a grilling tool and heat is applied to the material M to cook the material M, wherein:
the main body case comprises a plurality of pillar main body cases extending from an upper surface of a lower main body case, provided therein with a vertically-arranged electric heating means, and coupled to each other, and
when the plurality of pillar main body cases are coupled to each other, an inner space is vertically formed,
a heat-resistant container through which infrared light is transmitted, having only an upper opening, having a long rectangular barrel or cylindrical shape in a height direction, and made of a material through which infrared light is transmitted, such as glass or the like is arranged in the vertically formed inner space, thereby providing a structure in which infrared radiation passes through the heat-resistant container and is directly applied to an inside of the heat-resistant container, and
the grilling tool is arranged inside the heat-resistant container, the grilling tool allowing the material M to be mounted thereon and being capable of heating and cooking the material M.

2. The electric grill according to claim 1, wherein the plurality of pillar main body cases coupled to each other has a tetragonal barrel shape or a tetragonal barrel shape with a cylindrical inner space.

3. The electric grill according to claim 1, wherein, to prevent an increase in temperature of an exterior of the main body case, each pillar main body case has a plurality of air holes in a side surface thereof, and the lower main body case has a plurality of air holes in a lower surface thereof.

4. The electric grill according to claim 1, further comprising a cap on an upper portion of the heat-resistant container.

5. The electric grill according to claim 1, wherein the heat-resistant container comprises a handle protruding laterally and configured to hold the heat-resistant container, and at least one slit is provided from an upper end portion to a middle portion of the main body case and configured to guide the protruding handle of the heat-resistant container to be accommodated therein, when the plurality of pillar main body cases are coupled to each other.

6. The electric grill according to claim 1, wherein a circumferential surface of the heat-resistant container is made of heat-resistant glass, and a lower surface thereof is made of a heat-resistant material different from the heat-resistant glass of the circumferential surface, thereby preventing occurrence of cracks in the heat-resistant container.

7. The electric grill according to claim 1, wherein the grilling tool comprises a grill handle configured to hold the grilling tool, a pair of grills provided below the grill handle and on which the material M to be cooked is mounted, a pair of fasteners that fasten the pair of grills to rigidly mount the material M to be cooked, and a locking loop that fixes a fastened state of the pair of fasteners.

8. The electric grill according to claim 4, wherein the cap comprises a filter that filters polluted gases including odors generated during cooking and discharges the gases to an outside, and further comprises a cap accommodation hole in a side surface of the cap, the cap accommodation hole being capable of accommodating an outwardly-protruding portion of the grilling tool.

9. The electric grill according to claim, wherein the heat-resistant container comprises a handle protruding laterally and configured to hold the heat-resistant container, and at least one slit is provided from an upper end portion to a middle portion of the main body case and configured to guide the protruding handle of the heat-resistant container to be accommodated therein, when the plurality of pillar main body cases are coupled to each other.
